(19) United States
(12) Patent Application Publication
(10) Pub. No.: US 2021/0255504 A1
(43) Pub. Date: Aug. 19, 2021

(54) DISPLAY APPARATUS

(71) Applicant: SHARP KABUSHIKI KAISHA, Sakai City (JP)

(72) Inventors: KENICHI SANUKI, Sakai City (JP); SHIGENORI MORIOKA, Sakai City (JP); NOBUAKI SUGIHARA, Sakai City (JP); MASAFUMI ITO, Sakai City (JP)

(21) Appl. No.: 17/175,320

(22) Filed: Feb. 12, 2021

(30) Foreign Application Priority Data
Feb. 14, 2020 (JP) 2020-023830

(51) Int. Cl. G02F 1/1335; G02F 1/1343

(52) U.S. Cl. CPC G02F 1/133528; G02F 1/133509; G02F 1/134309

(57) ABSTRACT

A display apparatus comprises a light-transmitting cover that transmits light; a display panel including at least a polarizer and a plurality of layers, the plurality of layers including a display layer, the polarizer having an opening through. which incoming light from the light-transmitting cover is allowed to pass into an imaging device, the imaging device being positioned opposite to the light-transmitting cover with respect to the display panel; and a filler that fills the opening, and transmits the incoming light.

### BACKGROUND

### 1. Field

The present disclosure relates to a display apparatus.

### 2. Description of the Related Art

Some known display apparatuses have a camera (imaging device) or other such component disposed within the display screen to achieve a narrower bezel. One exemplary display apparatus of this type is disclosed in, for example, Japanese Unexamined Patent Application Publication No. 2012-98726. In the display apparatus, printing is applied to the front panel to hide a portion of the display panel or to hide the camera body.

FIG. 4 illustrates a display apparatus 100 as an example of such a display apparatus with printing applied to the front panel. FIG. 4 is a schematic cross-sectional view of the display apparatus 100 according to related art. As illustrated in FIG. 4, the display apparatus 100 has an opening (gap) that extends through a backlight 20b, a liquid crystal panel 30b, and a bonding layer 40b. An imaging device 10b is installed in the opening. The liquid crystal panel 30b includes a first polarizer 31b, a liquid crystal panel glass part 32b, and a second polarizer 33b.

The display apparatus 100 includes a print layer PLb provided on a side of a front panel 50b over which the backlight 20b and the liquid crystal panel 30b are disposed. The print layer PLb is provided on the front panel 50b such that the print layer PLb is positioned clear of an angle of view R1 of the imaging device 10b and covers and hides the edges of the opening and the outer periphery of the imaging device 10b.

Providing the print layer PLb on the front panel 50b in this way may result in increased area of the print layer PLb, which may detract from the aesthetic design of the display apparatus 100. By contrast, reducing the area of the print layer PLb to give priority to aesthetic design may lead to degradation of camera performance.

It is desirable to obviate printing applied to the front panel, and enhance the aesthetic design of the display apparatus without compromising the performance of the imaging device.

### SUMMARY

According to an aspect of the disclosure, there is provided a display apparatus including a light-transmitting cover, a display panel, and a filler. The light-transmitting cover transmits light. The display panel includes at least a polarizer and plural layers, the plural layers including a display layer, the polarizer having an opening through which incoming light from the light-transmitting cover is allowed to pass into an imaging device, the imaging device being positioned opposite to the light-transmitting cover with respect to the display panel. The filler fills the opening, and transmits the incoming light.

### BRIEF DESCRIPTION OF THE DRAWINGS

FIG. 1 is a schematic cross-sectional view of a display apparatus according to Embodiment 1 of the present disclosure;

FIG. 2 is a schematic plan view of a portion of the display screen of the display apparatus illustrated in FIG. 1;

FIG. 3 is a schematic cross-sectional view of a display apparatus according to Embodiment 2 of the present disclosure; and

FIG. 4 is a schematic cross-sectional view of a display apparatus according to related art.

### DESCRIPTION OF THE EMBODIMENTS

### Embodiment 1

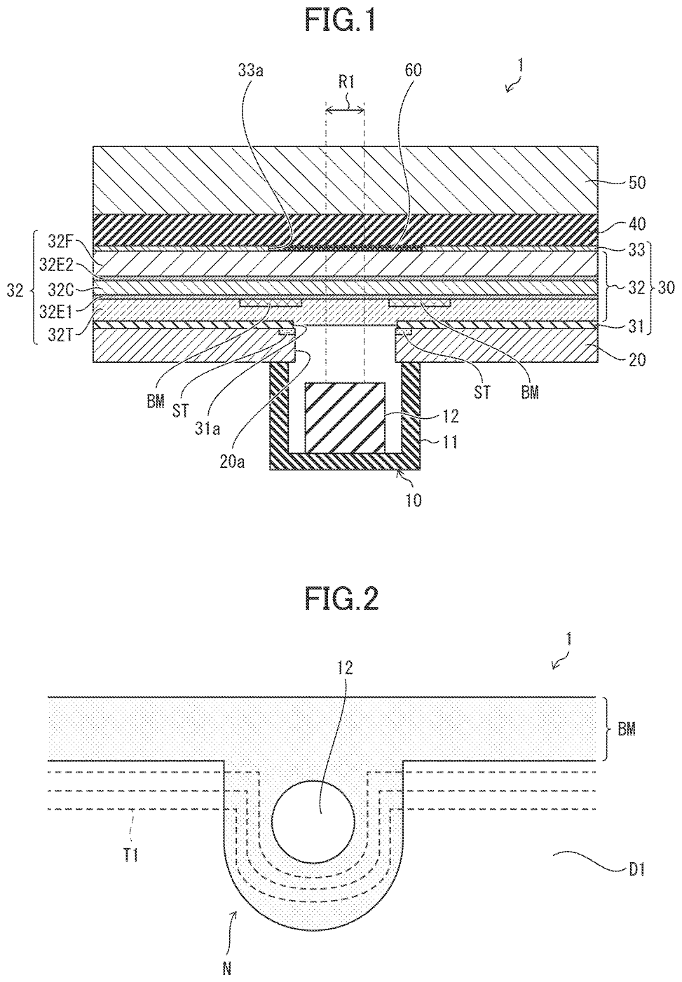

An embodiment of the present disclosure is described below with reference to FIGS. 1 and 2. The following description of Embodiment 1 is directed to an exemplary configuration in which an aspect of the present disclosure is applied to a display apparatus including a liquid crystal mane It is to be noted, however, that the following description is intended to illustrate one exemplary embodiment of the present disclosure and not to limit the present disclosure to the particular embodiment illustrated.

### Configuration of Display Apparatus

FIG. 1 is a schematic cross-sectional view of a display apparatus 1 according to Embodiment 1 of the present disclosure. FIG. 2 is a schematic plan view of a portion of a display screen D1 of the display apparatus 1 illustrated in FIG. 1. Areas near where a front panel (light-transmitting cover) 50 is located in FIG. 1 will be hereinafter sometimes referred to as front side, and areas near where an imaging device 10 is located in FIG. 1 will be hereinafter sometimes referred to as back side.

As illustrated in FIG. 1, the display apparatus 1 is provided with the imaging device 10, a backlight 20, a liquid crystal panel (display panel) 30, a bonding layer 40, a front panel (light-transmitting cover) 50, a filler 60, and a light-shielding tape ST. As illustrated in FIG. 2, the display apparatus 1 is a camera-equipped display apparatus having a notch (cutout) N at one outer edge (e.g., upper edge) of the display screen D1 of the display apparatus 1, with an imaging unit 12 (the imaging device 10) disposed in the notch N.

### Imaging Device

The imaging device 10 includes a housing 11, and the imaging unit 12. The housing 11 accommodates the imaging unit 12. The housing 11 is open at its side near the front panel 50 such that light entering from outside of the display apparatus 1, that is, light entering through the front panel 50 is allowed to be incident on the imaging unit 12. The housing 11 is mounted to a side (back side) of the backlight 20 opposite to the side on which the liquid crystal panel 30 is provided. This helps to ensure that, with the display apparatus 1 viewed from the front panel 50, the outer periphery of the housing 11 of the imaging device 10 is not visible due to the presence of the backlight 20. The imaging unit 12 receives incoming light entering from outside of the display apparatus 1 (through the front panel 50), and generates image data responsive to the received incoming light. The imaging unit 12 includes a lens, an image sensor, and other components.

### Backlight

The backlight 20 emits light toward the liquid crystal panel 30 that includes three wavelengths of color used to display an image, that is, red, green, and blue. Examples of the backlight 20 include a light source with plural white light emitting diodes (LEDs). The imaging device 10 is disposed on the back side of the backlight 20. The liquid crystal panel 30 is disposed on the front side of the backlight 20. The backlight 20 has an opening 20a wider than the angle of view R1 of the imaging device 10 such that light entering from outside of the display apparatus 1 is allowed to pass through the opening 20a into the imaging device 10.

### Liquid Crystal Panel

The liquid crystal panel 30 is stacked on the backlight 20, and disposed between the backlight 20 and the bonding layer 40. The liquid crystal panel 30 includes a first polarizer 31, a liquid crystal panel glass part 32, and a second polarizer (polarizer) 33, which are stacked in this order as viewed from the backlight 20.

The first polarizer 31 and the second polarizer 33 each represent a layer that polarizes light emitted from the backlight 20. The first polarizer 31 is disposed near the backlight 20, and the second polarizer 33 is disposed near the bonding layer 40. That is, the second polarizer 33 is disposed on a side (front side) of the liquid crystal panel glass part 32 opposite to the side (back side) on which the first polarizer 31 is disposed.

The first polarizer 31 has an opening 31a wider than the angle of view R1 such that light entering from outside of the display apparatus 1 is allowed to pass through the opening 31a into the imaging device 10. Likewise, the second polarizer 33 has an opening 33a wider than the angle of view R1 such that light entering from outside of the display apparatus 1 is allowed to pass through the opening 33a into the imaging device 10. The opening 33a of the second polarizer 33 is filled with the filler 60 that transmits light entering from outside of the display apparatus 1.

The liquid crystal panel glass part 32 is disposed between the first polarizer 31 and the second polarizer 33. The liquid crystal panel glass part 32 includes a TFT-side glass substrate 32T, a black mask layer BM, a pixel electrode layer (electrode layer) 32E1, a liquid crystal molecule layer 32C (display layer), a counter electrode layer (electrode layer) 32E2, and a color filter-side glass substrate 32F.

Plural TFTs are arranged in a matrix on the TFT-side glass substrate 32T. The TFT-side glass substrate 32T is disposed between the first polarizer 31 and the pixel electrode layer 32E1.

The liquid crystal molecule layer 32C includes an arrangement of liquid crystal molecules extending continuously from one side of the cell gap to the other side. The liquid crystal molecule layer 32C is disposed between the TFT-side glass substrate 32T and the color filter-side glass substrate 32F, with the pixel electrode layer 32E1 and the counter electrode layer 32E2 being respectively interposed between the liquid crystal molecule layer 32C and the TFT-side glass substrate 32T and between the liquid crystal molecule layer 32C and the color filter-side glass substrate 32F to change the direction of orientation of the liquid crystal molecules. That is, the liquid crystal molecule layer 32C is disposed between the pixel electrode layer 32E1 and the counter electrode layer 32E2. The liquid crystal modules may be positioned clear of a portion of the liquid crystal molecule layer 32C located within the angle of view R1. In other words, only glass may be disposed in the portion of the liquid crystal molecule layer 32C located within the angle of view R1. Alternatively, however, the liquid crystal molecules may be disposed also in the portion of the liquid crystal molecule layer 32C located within the angle of view R1 of the imaging device 10.

The pixel electrode layer 32E1 and the counter electrode layer 32E2 each include a matrix arrangement of electrodes (transparent electrodes). In Embodiment 1, the pixel electrode layer 32E1 and the counter electrode layer 32E2 each include electrodes positioned clear of a portion of the layer located within the angle of view R1 of the imaging device 10. Consequently, incoming light passing through a portion of each of the pixel electrode layer 32E1 and the counter electrode layer 32E2 where no electrode is present can be directed into the imaging device 10 without being attenuated. Therefore, each of these electrode layers does not have to be provided with an opening through which incoming light is allowed to pass into the imaging device 10. This allows for reduced manufacturing cost of the display apparatus 1.

The black mask layer BM is disposed in a portion of the area between the TFT-side glass substrate 32T and the pixel electrode layer 32E1. The black mask layer BM is positioned closer to the imaging device 10 than the opening 33a of the second polarizer 33 is. The black mask layer BM is disposed in a location corresponding to the edges of the opening 20a of the backlight 20 and to the edges of the opening 31a of the first polarizer 31. The black mask layer BM covers and hides these edges to ensure that the edges are not visible from the front panel 50. As a result, with the display apparatus 1 viewed from the front panel 50, the edges of the opening 20a of the backlight 20, and the edges of the opening 31a of the first polarizer 31 are hidden by the black mask layer BM. This makes it possible to enhance the aesthetic design of the display apparatus 1. The black mask layer BM also has the function of blocking light that leaks from the edges of the opening 20a of the backlight 20.

The black mask layer BM is disposed so as to cover mostly electrical traces T1 within the display screen D1 (FIG. 2). The electrical traces T1 are provided on the TFT-side glass substrate 32T, and positioned along one outer edge (e.g., upper edge) of the display screen D1 and along the notch N. The presence of the black mask layer BM positioned to cover the electrical traces T1 ensures that with the display apparatus 1 viewed from the display screen D1, the electrical traces T1 are hidden by the black mask layer BM. This makes it possible to enhance the aesthetic design of the display apparatus 1. Unlike with related art, the display apparatus 1 has no opening provided in the liquid crystal panel glass part 32 to allow incoming light to enter the imaging device 10. This configuration makes it possible to reduce the size of the notch N and the number of electrical traces T1. Therefore, the outer periphery of the black mask layer BM can be reduced in width.

The color filter-side glass substrate 32F is provided with a color filter including colored filter pixel elements (e.g., red, green, and blue filter elements) for displaying a color image on the display screen D1. The color filter-side glass substrate 32F is disposed between the counter electrode layer 32E2 and the second polarizer 33. A portion of the color filter-side glass substrate 32F may be transparent. For example, a portion of the color filter located within the angle of view R1 may lack colored filter pixel elements. This allows light entering from outside of the display apparatus 1 to enter the imaging device 10 without passing through colored filter pixel elements.

### Bonding Layer

The bonding layer 40 bonds the front panel 50 and the liquid crystal panel 30 to each other. The bonding layer 40 may be made of, for example, optical clear adhesive (OCA). This allows light emitted from the backlight 20 to pass through the bonding layer 40 and exit from the front panel 50. The bonding layer 40 is disposed between the second polarizer 33 and the front panel 50.

The bonding layer 40 bonds the front panel 50 and the second polarizer 33 to each other with the bonding layer 40 in close contact with the filler 60. The close contact between the bonding layer 40 and the filler 60 ensures that no gap is present between the bonding layer 40 and the filler 60. This helps to reduce, for example, refraction of incoming light resulting from the presence of such a gap, thus allowing for reduced distortion of an image produced by the imaging device 10.

### Front Panel

The front panel 50 is a light-transmitting cover that transmits light. The front panel 50 is made of a material such as glass or resin that transmits light. The front panel 50 defines the outermost surface of the display apparatus 1.

### Filler

The filler 60 fills the opening 33a of the second polarizer 33, and transmits light entering from outside of the display apparatus 1. The filer 60 may be made of, for example, optical clear adhesive (OCA), liquid optical clear adhesive (glue), or other materials. However, the material of the filler 60 is not particularly limited. Rather, the filler 60 may be made of any material that transmits incoming light without refracting the incoming light.

Filling the opening 33a of the second polarizer 33 with one filler 60 ensures that the edges of the opening 33a are not easily visible from the front panel 50. Therefore, unlike with related art, printing does not have to be applied to the front panel 50 to hide the edges of the opening 33a.

The filler 60 may have a thickness equal to the thickness of the second polarizer 33, or may have a thickness greater than the thickness of the second polarizer 33. As a result of the filler 60 having a thickness greater than or equal to the thickness of the second polarizer 33 as described above, the front panel 50 and the second polarizer 33 can be suitably bonded to each other by the bonding layer 40 with the bonding layer 40 in close contact with the filler 60.

### Light-Shielding Tape

The light-shielding tape ST is disposed between the backlight 20 and the first polarizer 31. The light-shielding tape ST is disposed along an edge of the opening 20a of the backlight 20 near the first polarizer. Covering the above-mentioned edge of the opening 20a with the light shielding tape ST in this way makes it possible to block light exiting from the edge.

### Operation and Effect of Display Apparatus

As described above, the display apparatus 1 includes the front panel 50, the liquid crystal panel 30, and the filler 60. The front panel 50 transmits light. The liquid crystal panel 30 includes the second polarizer 33 with the opening 33a through which incoming light from the front panel 50 is allowed to pass into the imaging device 10. The filler 60 fills the opening 33a, and transmits the incoming light.

As described above, the display apparatus 1 includes the filler 60 that fills the opening 33a defined in the second polarizer 33. This ensures that the edges of the opening are less easily visible from the front panel 50. Therefore, unlike with related art, printing does not have to be applied to the front panel 50 to hide the edges of the opening 33a. Further, this configuration allows a notch, a hole, or other such opening in the display apparatus to be reduced in size without compromising the performance of the imaging device 10, thus allowing for increased size of the display screen D1 and enhanced aesthetic design of the display apparatus 1.

### Modifications

In one aspect of the present disclosure, various display panels other than a liquid crystal panel may be employed as a display panel. A display panel may generally be made of any suitable type of display structure. Examples of a display structure that may be used as a display panel include a liquid crystal display (LCD) structure, an organic light-emitting diode (OLED) structure, a plasma cell structure, and an electronic ink display structure.

In one aspect of the present disclosure, the opening defined in the second polarizer may be a cutout formed by cutting one outer edge of the second polarizer in the direction of thickness of the second polarizer, or may be a through-hole that penetrates the second polarizer in the direction of thickness of the second polarizer.

### Embodiment 2

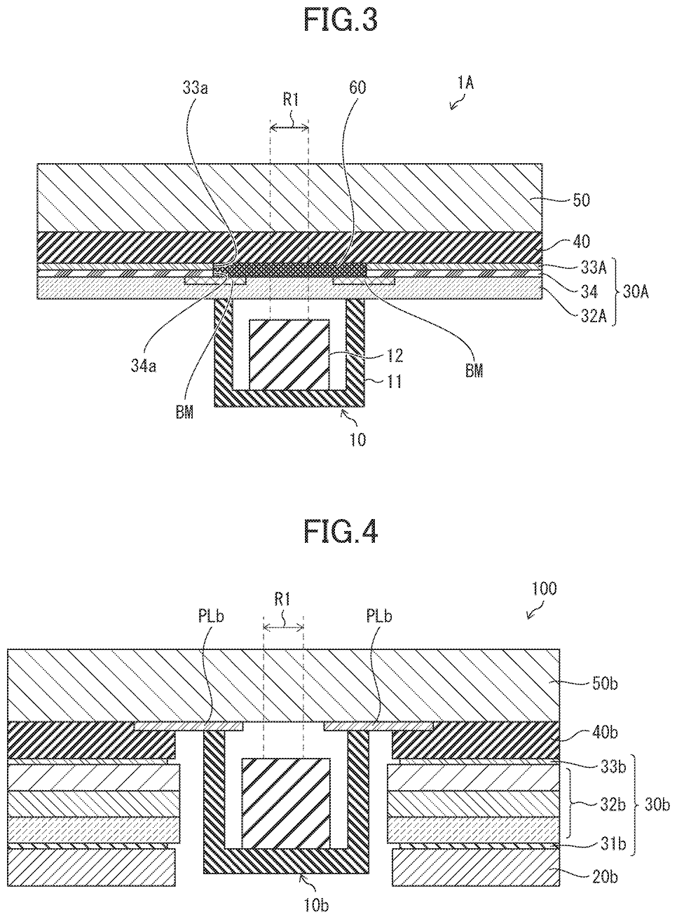

Another embodiment of the present disclosure is described below with reference to FIG. 3. The following description of Embodiment 2 is directed to an exemplary configuration in which an aspect of the present disclosure is applied to a display apparatus including an organic EL panel. For the convenience of explanation, components identical in function to the components described above with reference to Embodiment 1 are designated by the same reference signs, and their descriptions are not repeated.

### Configuration of Display Apparatus

FIG. 3 is a schematic cross-sectional view of a display apparatus 1A according to Embodiment 2 of the present disclosure. As illustrated in FIG. 3, the display apparatus 1A differs from the display apparatus 1 mostly in that the display apparatus 1A includes an organic. EL panel (display panel) 30A instead of the liquid crystal panel 30, and that the display apparatus 1A additionally includes a touch panel 34.

As illustrated in FIG. 3, the display apparatus 1A includes the imaging device 10, the organic. EL panel 30A, the bonding layer 40, the front panel 50, and the filler 60.

### Imaging Device

The imaging device 10 includes the housing 11, and the imaging unit 12. The housing 11 is mounted to a side (back side) of the organic EL panel 30A opposite to the side on which the bonding layer 40 is disposed.

### Organic EL Panel

The organic EL panel 30A includes an organic EL panel body 32A, the touch panel 34, and a polarizer 33A. In Embodiment 2, the organic EL panel 30A includes the organic EL panel body 32A, the touch panel 34, and the polarizer 33A, which are stacked in this order as viewed from the imaging device 10. It is to be noted, however, that the relative placement of the touch panel 34 and the polarizer 33A may be reversed.

A known structure may be employed as the basic structure of the organic EL panel body 32A. Accordingly, although not described in detail, an exemplary configuration of the organic EL panel body 32A is such that a hole injection layer/organic EL layer (display layer) is sandwiched between two transparent electrode layers (electrode layers). The organic EL panel body 32A is made of, for example, a glass or rigid material. The organic EL panel body 32A includes the black mask layer BM.

The black mask layer BM is disposed in contact with the back side of the touch panel 34 such that the black mask layer BM is positioned closer to the imaging device 10 than the opening 33a of the polarizer 33A is. The black mask layer BM covers and hides the outer periphery of the housing 11 of the imaging device 10 mounted to the organic EL, panel 30A, such that the outer periphery is not visible from the front panel 50. As a result, with the display apparatus 1A viewed from the front panel 50, the above-mentioned outer periphery of the housing 11 is hidden by the black mask layer BM. This makes it possible to enhance the aesthetic design of the display apparatus 1A.

### Touch Panel

The touch panel 34 accepts a user's touch operation on the display screen D1. The touch panel 34 may include an array of capacitive electrodes (e.g., transparent electrodes such as indium tin oxide electrodes). Alternatively, the touch panel 34 may include a touch sensor array based on touch sensing techniques other than those based on capacitive electrodes (e.g., resistive touch sensor structures, acoustic touch sensor structures, piezoelectric sensors, and other stress sensor structures). The panel 34 has an opening 34a wider than the angle of view R1 of the imaging device 10 such that light entering from outside of the display apparatus 1A is allowed to pass through the opening 34a into the imaging device 10.

### Filler

The filler 60 fills the opening 34a of the touch panel 34 and the opening 33a of the polarizer 33A, and transmits light entering from outside of the display apparatus 1A. The filler 60 may have a thickness equal to the sum of the respective thicknesses of the touch panel 34 and the polarizer 33A, or may have a thickness greater than the sum of the respective thicknesses of the touch panel 34 and the polarizer 33A. As a result of the filler 60 having a thickness greater than or equal to the sum of the respective thicknesses of the touch panel 34 and the polarizer 33A, the front panel 50 and the polarizer 33A can be suitably bonded to each other by the bonding layer 40 with the bonding layer 40 in close contact with the filler 60.

### Operation and Effect of Display Apparatus

As described above, the display apparatus 1A includes the front panel 50, the organic EL panel 30A, and the filler 60. The front panel 50 transmits light. The organic EL and 30A includes the polarizer 33A with the opening 33a through which incoming light from the front panel 50 is allowed to pass into the imaging device 10. The filler 60 fills the opening 33a, and transmits the incoming light.

As described above, the di apparatus 1A includes the filler 60 that the opening 33a defined in the polarizer 33A. This ensures that the edges of the opening 33a are less easily visible from the front panel 50. Therefore, unlike with related art, printing does not have to be applied to the front panel 50 to hide the edges of the opening 33a. Further, this configuration allows a notch, a hole, or other such opening in the display apparatus 1A to be reduced in size without compromising the performance of the imaging device 10, thus allowing for increased size of the display screen D1 and enhanced aesthetic design of the display apparatus 1A.

### Concluding Remarks

A display apparatus according to a first aspect of the present disclosure includes a light-transmitting cover (the front panel 50), a display panel (the liquid crystal panel 30 or the organic EL panel 30A), and a filler. The light-transmitting cover transmits light. The display panel includes at least a polarizer (the second polarizer 33 or the polarizer 33A) and plural layers, the plural layers including a display layer (the liquid crystal molecule layer 32C), the polarizer having an opening through which incoming light from the light-transmitting cover is allowed to pass into an imaging device, the imaging device being positioned opposite to the light-transmitting cover with respect to the display panel. The filler fills the opening, and transmits the incoming light.

According to the configuration mentioned above, the filler fills the opening defined the polarizer. This ensures that the edges of the opening are less easily visible from the light-transmitting cover. Therefore, unlike with related art, printing does not have to be applied to the light-transmitting cover to hide the edges of the opening. Further, this configuration allows a notch or a hole in the display apparatus to be reduced in size without compromising the performance of the imaging device, thus allowing for increased size of the display screen and enhanced aesthetic design of the display apparatus.

According to a second aspect of the present disclosure, in the display apparatus according to the first aspect, the display apparatus may further include a bonding layer that bonds the light-transmitting cover and the display panel to each other, and the bonding layer may bond the light-transmitting cover and the polarizer to each other with the bonding layer in close contact with the filler.

According to the configuration mentioned above, the close contact between the bonding layer and the filler ensures that no gap is present between the bonding layer and the filler. This helps to reduce, for example, refraction of incoming light resulting from the presence of such a gap, thus allowing for reduced distortion of an image produced by the imaging device.

According to a third aspect of the present disclosure, in the display apparatus according to the second aspect, the filler may have a thickness equal to a thickness of the polarizer, or may have a thickness greater than the thickness of the polarizer.

According to the configuration mentioned above, the filler that fills the opening defined in the polarizer has a thickness greater than or equal to the thickness of the polarizer. This allows the light-transmitting cover and the polarizer to be suitably bonded to each other with the bonding layer in close contact with the filler.

According to a fourth aspect of the present disclosure, in the display apparatus according to any one of the first to third aspects, the display panel may include an electrode layer (each of the pixel electrode layer 32E1 and the counter electrode layer 32E2), the electrode layer including plural electrodes, and the plural electrodes may be positioned clear of a portion of the electrode layer located within the angle of view (R1) of the imaging device.

The configuration mentioned above allows the imaging device to receive incoming light passing through a portion of the electrode layer where no electrode is present. Therefore, the electrode layer does not have to be provided with an opening through which incoming light is allowed to pass into the imaging device. This allows for reduced manufacturing cost of the display apparatus.

According to a fifth aspect of the present disclosure, in the display apparatus according to any one of the first to fourth aspects, the display panel may include a black mask layer that makes the interior of the display apparatus not visible through the opening from the light-transmitting cover, and the black mask layer may be positioned closer to the imaging device than the opening is.

The configuration mentioned above allows the black mask layer to be positioned near the imaging device, thus making it possible to reduce the width of the outer periphery of the black mask layer.

According to a sixth aspect of the present disclosure, in the display apparatus according to any one of the first to fifth aspects, the filler may be made of a material that does not refract the incoming light.

According to the configuration mentioned above, the filler is made of a material that does not refract incoming light. This allows for reduced distortion of an image produced by the imaging device.

The present disclosure contains subject matter related to that disclosed in Japanese Priority Patent Application JP 2020-023830 filed in the Japan Patent Office on Feb. 14, 2020, the entire contents of which are hereby incorporated by reference.

The present disclosure is not limited to the embodiments mentioned above but various modifications or alterations are possible within the scope of the appended claims. Embodiments obtained by appropriately combining technical measures disclosed in different embodiments also fall within the technical scope of the present disclosure. Further, technical measures disclosed in individual embodiments may be combined to provide new technical features.

While there have been described what are at present considered to be certain embodiments of the disclosure, it will be understood that various modifications may be made thereto, and it is intended that the appended claims cover all such modifications as fall within the true spirit and scope of the disclosure.

It should be understood by those skilled in the art that various modifications, combinations, sub-combinations and alterations may occur depending on design requirements and other factors insofar as they are within the scope of the appended claims or the equivalents thereof.

What is claimed is:

1. A display apparatus comprising:
a light-transmitting cover that transmits light;
a display panel including at least a polarizer and a plurality of layers, the plurality of layers including a display layer, the polarizer having an opening through which incoming light from the light-transmitting cover is allowed to pass into an imaging device, the imaging device being positioned opposite to the light-transmitting cover with respect to the display panel; and
a filler that fills the opening, and transmits the incoming light.

2. The display apparatus according to claim 1, further comprising
a bonding layer that bonds the light-transmitting cover and the display panel to each other,
wherein the bonding layer bonds the light-transmitting cover and the polarizer to each other with the bonding layer in close contact with the filler.

3. The display apparatus according to claim 2, wherein the filler has a thickness equal to a thickness of the polarizer, or has a thickness greater than the thickness of the polarizer.

4. The display apparatus according to claim 1,
wherein the display panel includes an electrode layer, the electrode layer including a plurality of electrodes, and
wherein the plurality of electrodes are positioned clear of a portion of the electrode layer located within an angle of view of the imaging device.

5. The display apparatus according to claim 1,
wherein the display panel includes a black mask layer that makes an interior of the display apparatus not visible through the opening from the light-transmitting cover, and
wherein the black mask layer is positioned closer to the imaging device than the opening is.

6. The display apparatus according to claim 1, wherein the filler is made of a material that does not refract the incoming light.
